(19) United States
(12) Patent Application Publication
(10) Pub. No.: US 2019/0299794 A1
(43) Pub. Date: Oct. 3, 2019

(54) System and Method for Vehicle Telematics for Electric Vehicle

(71) Applicant: Valvoline Licensing and Intellectual Property, LLC, Lexington, KY (US)

(72) Inventors: Adam E. Sworski, Catlettsburg, KY (US); Frances E. Lockwood, Georgetown, KY (US); Roger D. England, Lexington, KY (US); Timothy L. Caudill, Catlettsburg, KY (US); Jeffrey S. Baker, Lexington, KY (US); Jeffrey R. Torkelson, Lexington, KY (US)

(73) Assignee: Valvoline Licensing and Intellectual Property, LLC, Lexington, KY (US)

(21) Appl. No.: 15/937,151

(22) Filed: Mar. 27, 2018

(51) Int. Cl. B60L 11/18; G07C 5/08; G06Q 20/32; G06Q 50/06

(52) U.S. Cl. CPC B60L 11/1848; G07C 5/085; B60L 2240/62; G06Q 50/06; B60L 11/1861; G06Q 20/325

(57) ABSTRACT

Systems and methods are described for tracking charge information of a vehicle. A sensor monitors one or more parameters of the vehicle over a period of time. A telematics device receives and processes the parameters to determine a vehicle telematics information. The telematics device transmits the vehicle telematics information to an entity device.

### TECHNICAL FIELD

This disclosure generally relates to systems and methods for vehicle telematics, and more particularly to vehicle telematics for tracking charging of electric vehicles, e.g., for taxation, etc.

### BACKGROUND

An electric vehicle (EV) charging station, also called electric recharging point, charging point, charge point and electric vehicle supply equipment (EVSE), supplies electric energy for the recharging of electric vehicles, such as plug-in electric vehicles, including electric cars, neighborhood electric vehicles and plug-in hybrids. As plug-in hybrid electric vehicles and battery electric vehicle ownership expands, charging stations can become more widely distributed. Charging stations can include publically accessible stations, on-street or at retail facilities, home charging stations, office charging stations, etc. The charging stations can be provided by electric utility companies and/or private companies.

### SUMMARY

According to some aspects, systems and methods provide for tracking charge information of a vehicle. A sensor monitors one or more parameters of the vehicle over a period of time. A telematics device receives and processes the parameters to determine a vehicle telematics information. The telematics device transmits the vehicle telematics information to an entity device.

Other systems, methods, features, and advantages is or will become apparent upon examination of the following figures and detailed description. It is intended that all such additional systems, methods, features, and advantages be included within this description and be protected by the accompanying claims.

### BRIEF DESCRIPTION OF THE DRAWINGS

FIG. 1 is a block diagram of an example environment for tracking information related to hybrid and electric vehicles.

FIG. 2 is a flowchart of an example logic of the telematics device.

FIG. 3 is a flowchart of an example logic of the charge determination module.

FIG. 4 is a flowchart of an example logic of the user device.

FIG. 5 is a block diagram of an example computing device.

### DETAILED DESCRIPTION

The disclosure generally relates to systems and methods for providing vehicle telematics system for hybrid and/or electric vehicle charging systems. In some examples, information, including one or more of miles driven, energy consumed, location information, charging details, etc., can be tracked by the telematics system. In some examples, the tracked information can be processed, for example to determine charges to be posted to an online account for user payment and other interactions. In some examples, the processed information can be used to determine and pay road taxes, e.g., based on state and/or federal regulations, and/or other fees. In some examples, mobile devices need not be included to interact within the charging systems, which can provide for efficient and cost effective handling of tracked information, whether charging the electric or hybrid vehicle at home, at the office, at dedicated charging stations, etc. This can provide for efficient and cost effective tracking of charged vehicles.

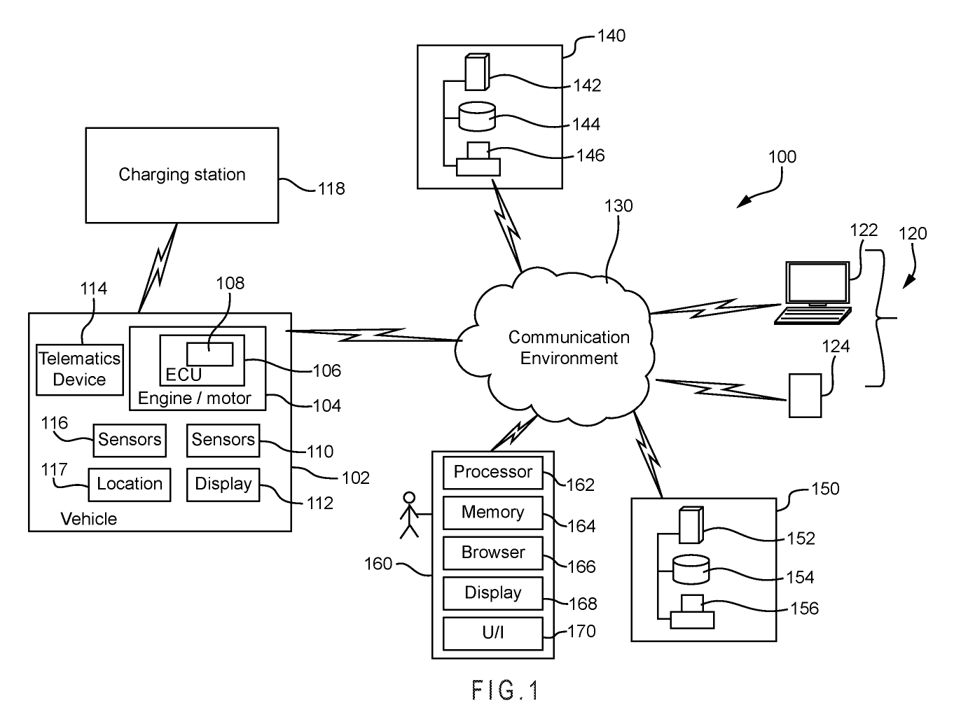

FIG. 1 is a block diagram of an example environment 100 for tracking information related to charging electric and hybrid vehicles, generally referred to as vehicle 102. The vehicle 102 can include one or more residential, commercial and/or industrial type vehicles, etc. The vehicle 102 can be driven by one or more engines and/or motors 104, e.g., internal combustion engines and/or electric motors. An electronic control unit (ECU) 106 is in communication with the engine/motor 104, to send control information to the engine/motor 104 and receive feedback information from the engine/motor 104 and/or other parts of the vehicle 102. The ECU 106 can also communicate with one or more of a charge determination module 108, sensors. 110, one or more displays 112, including audible and/or visual displays, a telematics device 114, batteries 116 and a location device 117.

The batteries 116 can be charged by a charging station 118, which includes publically accessible and/or private charging stations. Some charging stations 118 can support faster charging at higher voltages and currents than are available from residential EVSEs. The charge determination module 108, which tracks charge information for the vehicle 102, can be a part of the ECU 106 and/or implemented separately from the ECU 106. In some examples, the charge determination module 108 is positioned on the vehicle 102, but in other examples the charge determination module 108 can be positioned remotely from the vehicle 102. The location device 117 can include a global positioning system (GPS) device, including one or more of satellite-based positioning systems, cellular based positioning systems, etc. In some examples, the location device 117 is incorporated into the telematics device 114.

The telematics device 114 provides communication links between the vehicle 102 and other entity devices, including but not limited to, fleet management companies 120, electric vehicle infrastructure companies 140, government entities 150, user devices 160, etc., e.g., via a communication environment 130, vehicle to vehicle (V2V) and/or vehicle to infrastructure (V2I) communications. The communication environment 130 can include wireless and/or wired communication mediums, including but not limited to, cellular communications, satellite communications, WiFi, Bluetooth, Ethernet, etc. The electric vehicle infrastructure companies 140 can include one or more servers 142, memory 144 and computers 146. The servers 142 and/or the memory 144 can be located on-site and/or located remotely from offices of the electric vehicle infrastructure companies 140, e.g., located in a remote computing environment, for example, a private or public cloud environment. The government entities 150 can include one or more servers 152, memory 154 and computers 156. The servers 152 and/or the memory 154 can be located on-site and/or located remotely from offices of the government entities 150, e.g., located in a remote computing environment, for example, a private or public cloud environment.

The fleet manager devices 120 can include one or more of web portal devices 122 and/or mobile devices 124 for displaying vehicle charging related information. Mobile devices 124 can include, but are not limited to, smart phones, tablets, personal digital assistants, etc. Web portal devices 122 can include one or more personal computers, laptop computers, etc. In some examples, the mobile devices 124 can act as web portals, e.g., via a web browser of the mobile devices 124. The user device 160 can include one or more mobile a processor 162, a memory 164, a browser 166, a display 168 and a user interface (U/I) 170. In some examples, the user device 160 is a mobile device, including, but not limited to, smart phones, tablets, personal digital assistants, etc. In other examples, the user device 160 is a personal computer.

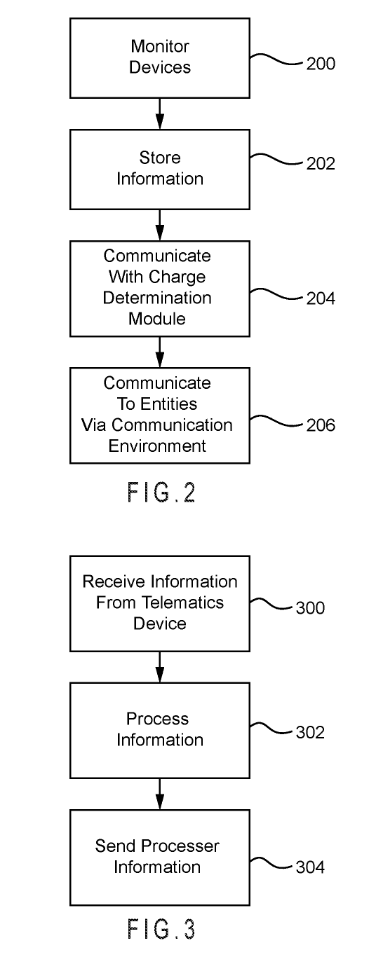

FIG. 2 is a flowchart of an example logic of the telematics device 114. The telematics device 114 can monitor information from one or more devices/systems of the vehicle 102, including but not limited to, the engine/motor 104, the sensors 110, the batteries 116, the location device 117 and the charging station 118 (200). The telematics device 114 can store, at least temporarily, information related to the monitoring, including, but not limited to, miles driven, energy consumed, location information, e.g., location when charging the vehicle 102, charging details, amount of charge at the various locations, type of charging station 118, etc. (202). The sensors 110 can include one or more wheel sensors to determine miles driven, battery sensors to determine energy consumed, voltage and/or current sensors to determine charge information, etc. Information from the sensors can also be time stamped with a clock, e.g. of the telematics device 114, and/or location stamped to determine a time of location when the telematics device 114 received the information. In some examples, some or all of the tracked information is not stored by the telematics device 114 but directly passed along to other devices without storing the information. In some examples, the telematics device 114 communicates the tracked information to the charge determination module 108, e.g., to process the information to determine charge related information, as described in more detail below (204).

In some examples, the telematics device 114 communicates the tracked information to other entities, e.g., the servers 142, 152 and/or fleet manager devices 120 (206). In some examples, the telematics device 114 communicates charge information as determined by the charge determination module 108 from the vehicle 102 to the servers 142, 152 and/or fleet manager devices 120. In other examples, the telematics device 114 sends raw data to the servers 142, 152 and/or fleet manager devices 120, e.g., to determine charge related information for the vehicle 102. In some examples the charge determination module 108, or parts of it, can be implemented as program or an app on the servers 142, 152 or fleet manager devices 120, for determining and/or displaying charge related information. The memories 144, 154 can store instructions which when executed by the servers 142, 152 perform some or all of the logic described herein. Additionally or alternatively, the telematics device 114 can send the raw or processed information to user device 160 for processing and/or display.

The telematics device 114 can associate vehicle identification information, e.g., vehicle identification number (VIN) and vehicle description, with the monitored/determined telematics information, including, but not limited to, miles driven, energy consumed, location of charge information, other charging details, e.g., amount of charge, etc., for sending to the entity devices. The entity devices, e.g., one or more of the fleet management companies 120, electric vehicle infrastructure companies 140, government entities 150, user devices 160, etc., can receive the vehicle identification and other information from the telematics device 114, and associate the received information with individual owners and/or drivers of the vehicle. The telematics device 114 and/or the entity device can associate a credit card, debit card bank account, etc. of the individual with the telematics information. The entity devices can charge the individual based on the received information for charges including, but not limited to, state and/or federal taxes, autonomous driving and/or car sharing charges, etc. In some examples, the vehicles 102 and/or entity device include readers for credit card chips for purpose of payment, in autonomous or other vehicles.

FIG. 3 is a flowchart of an example logic of the charge determination module 108. The charge determination module 108 can receive vehicle charging related information from the telematics device 114 (300). Received information can include, but is not limited to, miles driven, energy consumed, location of charge information, other charging details, e.g., amount of charge, etc. For example, the charge determination module 108 can process the received information to determine when and where the vehicle 102 was charged, an amount the vehicle 102 was charged, a cost of the charging, how many miles were driven between charges, where the car drove between charges, etc. (302). In some examples, the vehicle telematics information further includes information on a duration that the vehicle 102 spends in determined geo-fenced locations, e.g., within determined state lines, on specified highways, crossing determined bridges, etc. In this way, the charge determination module 108 can eliminate a need for a user to separately track when/where the vehicle 102 is being charged, e.g., at home, the office, a dedicated charging station, etc. The entity devices can charge for energy, e.g., electricity to charge the vehicle 102, based on the vehicle telematics information. For example, the entity devices can charge for energy based on vehicle usage and an electricity supplier, e.g., utility company, other energy provider, or based on third party) pricing, e.g., solar or other renewable energy sources.

The charge determination module 108 can communicate with the telematics device 114 to provide the processed information to the telematics device 114, which can send the processed information to the servers 142, 152 and/or fleet manager devices 120 (304). In some examples, the telematics device 114 sends raw charge related data to the servers 142, 152 and/or fleet manager devices 120 to process the information. In some examples, the servers 142, 152 and/or fleet manager devices 120 can include the charge determination module 108. Additionally or alternatively, the telematics device 114 can send the raw or processed information to user device 160 for processing and/or display. The telematics device 114 can vary data sampling rates and/or compress the raw and/or processed data, e.g., including the vehicle telematics information, before storing the data and/or sending the data to the entity devices. In this way, the determined sampled and/or compressed data can be optimized for processing and/or storage based on determined algorithms. The determined sampled and/or compressed data can minimize cost of data transmission, e.g., to cloud storage and/or processing services, to the entity devices and/or other remote data locations.

In this way, the environment 100 for tracking information related to charging of electric or hybrid vehicles 102 can automatically handle tracking and charging at the vehicle level, e.g., without the need for third party applications. Additionally or alternative, there is no need for a phone to interact with a charging station 118 to obtain charging information, e.g., during charging. In some examples, the servers 142, 152 and/or fleet manager devices 120 can then charge back to an account of the vehicle user for user payment and other interactions. In some examples, the user device 160 can perform the interactions with the user. In some examples, the environment 100 for tracking information related to charging of electric or hybrid vehicles 102 can be used to pay road taxes and other government fees, e.g., based on the tracked information.

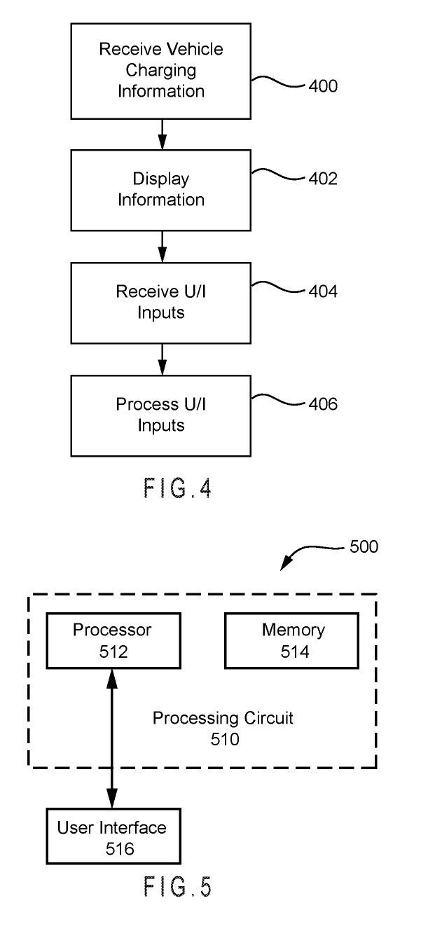

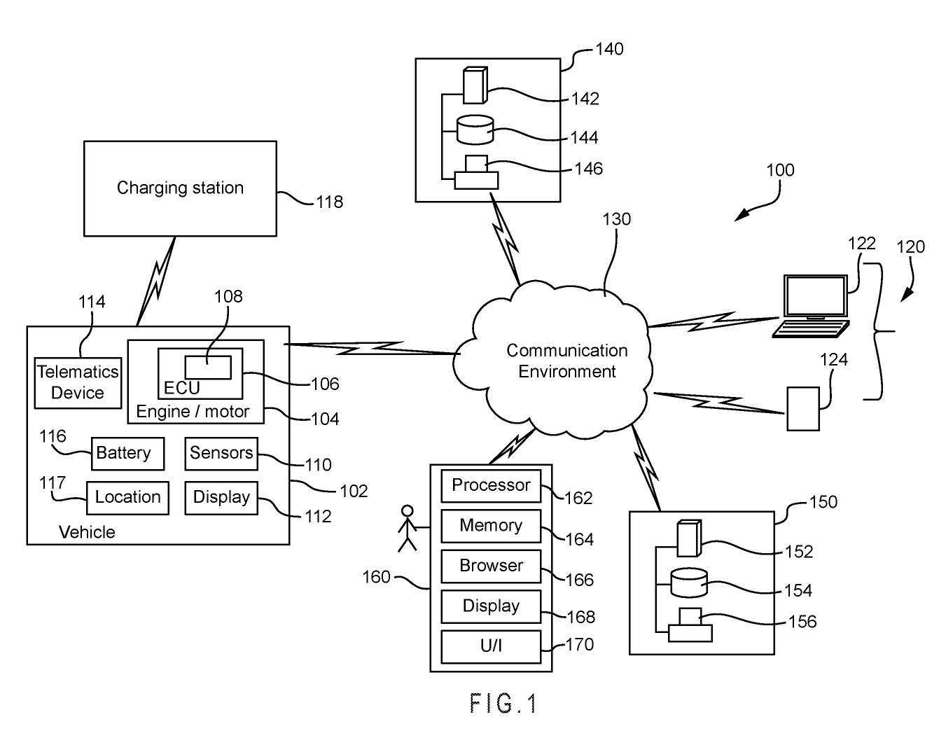

FIG. 4 is a flowchart of an example logic of the user device 160. The user device 160 can receive vehicle telematics information tracked by the telematics device 114 and/or processed by the charge determination module 108 (400). The user device 160 can display the information to the user, e.g., on display 168 via web browser 166 (402). In other examples, the user device 160 displays the information via a web portal or other application. The user device 160 can receive user inputs via the U/I 170 based on the displayed information (404). For example, the user device 160 can process the user inputs, e.g., to pay fees or taxes via the web browser 166 (406).

FIG. 5 is a block diagram of an example circuitry, e.g., for one or more of the ECU 106, servers 142, 152, fleet manager devices 120 and/or the mobile device 160. The ECU 106, servers 142, 152, fleet manager devices 120 and/or the mobile device 160 can include a processing circuit 510 which includes a processor 512 to process the information tracked by the telematics device 114. The processing circuit 510 can include hardware, software and/or firmware, or any combination thereof. The hardware can include electronic components on a printed circuit board, ceramic substrate or a thin laminate substrate, etc. Software can be stored in a memory 514, e.g., erasable, programmable read only memory (EPROMs) or flash memory, so the processor 512 can be re-programmed by uploading updated code, over-the-air (OTA) updates, or replacing chips. It will be appreciated that the components, devices or elements illustrated in and described with respect to FIG. 5 may not be mandatory and thus some may be omitted in certain examples. Additionally, some examples may include further or different components, devices or elements beyond those illustrated in and described with respect to FIG. 5.

In some examples, the processing circuitry 510 is configurable to perform actions in accordance with one or more examples disclosed herein. In this regard, the processing circuitry 510 may be configured to process tracked vehicle telematics information. The processing circuitry 510 may be configured to perform data processing, application execution and/or other processing and management services according to one or more examples. In some examples, the processing circuitry 510 or a portion(s) or component(s) thereof, may include one or more chipsets and/or other components that may be provided by integrated circuits.

The processor 512 may be embodied in a variety of forms. For example, the processor 512 may be embodied as various hardware-based processing means such as a microprocessor, a coprocessor, a controller or various other computing or processing devices including integrated circuits such as, for example, an ASIC (application specific integrated circuit), an FPGA (field programmable gate array), some combination thereof, or the like. Although illustrated as a single processor, it will be appreciated that the processor 512 may comprise a plurality of processors. The plurality of processors may be in operative communication with each other and may be collectively configured to perform one or more functionalities of the ECU 106, servers 142, 152, fleet manager devices 120 and/or the mobile device 160 as described herein. In some examples, the processor 512 may be configured to execute instructions that may be stored in the memory 514 or that may be otherwise accessible to the processor 512. As such, whether configured by hardware or by a combination of hardware and software, the processor 512 is capable of performing operations according to various examples while configured accordingly.

In some examples, the memory 514 may include one or more memory devices. Memory 514 may include fixed and/or removable memory devices. In some examples, the memory 514 may provide a non-transitory computer-readable storage medium that may store computer program instructions that may be executed by the processor 512. In this regard, the memory 514 may be configured to store information, data, applications, instructions and/or the like for enabling the ECU 106, servers 142, 152, fleet manager devices 120 and/or the mobile device 160 to carry out various functions in accordance with one or more examples. In some examples, the memory 514 may be in communication with one or more of the processor 512, the user interface 516 for passing information among components of the ECU 106, servers 142, 152, fleet manager devices 120 and/or the mobile device 160.

It is noted that the terms “substantially” and “about” may be utilized herein to represent an inherent degree of uncertainty that can be attributed to any quantitative comparison, value, measurement, or other representation. These terms are also utilized herein to represent a degree by which a quantitative representation may vary from a stated reference without resulting in a change in the basic function of the subject matter at issue.

While particular examples above have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A system for tracking charge information of a vehicle, comprising:
a sensor configured to monitor at least one parameter of the vehicle over a period of time;
a telematics device configured to receive and process the parameter to determine a telematics information, including at least one of a vehicle charging information, a location, a duration, and miles driven information; and
the telematics device configured to transmit the vehicle telematics information to an entity device.

2. The system of claim 1, where the entity device is configured to determine payment information and send the payment information to a user device for payment.

3. The system of claim 1, where the vehicle telematics information further comprises energy consumed.

4. The system of claim 1, where the entity device comprises a government entity.

5. The system of claim 1, where the entity device determines a tax due based on the vehicle telematics information.

6. The system of claim 1, where the entity device charges for energy based on the vehicle telematics information.

7. The system of claim 6, where the entity device further charges for energy based on vehicle usage and an electricity supplier.

8. The system of claim 1, further including a location device configured to provide location information to the telematics device based on a location of the vehicle during charging of the vehicle.

9. The system of claim 1, where the vehicle telematics information further includes information of a duration the vehicle spends in determined geo-fenced locations.

10. The system of claim 1, where the telematics device includes a time that the parameter was sensed.

11. The system of claim 1, where the telematics device includes a location that the parameter was sensed.

12. The system of claim 1, where the parameter includes a location of a charging station that the vehicle was charged.

13. A method, comprising:
receiving at a telematics device a determined parameter of a vehicle over a period of time;
processing the parameter to determine a vehicle telematics information, including at least one of a vehicle charging information, a location, a duration, and miles driven information; and
transmitting the vehicle charging information to an entity device.

14. The method of claim 13, further comprising compressing the vehicle telematics information for sending to the entity device.

15. The method of claim 13, further comprising determining payment information and sending the payment information to a user device for payment.

16. The method of claim 13, where the vehicle telematics information further comprises energy consumed.

17. The method of claim 13, where the entity device comprises a government entity.

18. The method of claim 13, further comprising determining a tax due based on the vehicle telematics information.

19. The method of claim 13, further comprising receiving a location information based on a location of the vehicle during charging of the vehicle.

20. The method of claim 13, further comprising receiving a time information based on when the parameter was sensed.

21. The method of claim 13, further comprising receiving a location information based on a location of the vehicle when the parameter was sensed.

22. The method of claim 13, further comprising receiving a location information based on a location of a charging station when the vehicle was charged.

23. The method of claim 13, where the vehicle telematics information further includes information of a duration the vehicle spends in determined geo-fenced locations.
